(19) United States
(12) Patent Application Publication
(10) Pub. No.: US 2022/0198780 A1
(43) Pub. Date: Jun. 23, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KENTARO DOBA, TOKYO (JP); SHUNICHI HOMMA, TOKYO (JP)

(21) Appl. No.: 17/598,131

(22) PCT Filed: Mar. 26, 2020
(86) PCT No.: PCT/JP2020/013698

§ 371 Date: Sep. 24, 2021

(30) Foreign Application Priority Data
Apr. 5, 2019 (JP) 2019-072630

(51) Int. Cl. G06V 10/74; G06T 7/521; G06T 7/90; G06T 7/70; G06F 3/01; G06T 19/00; G06V 20/64; G06Q 30/06

(52) U.S. Cl. CPC G06V 10/761; G06T 7/521; G06T 7/90; G06T 7/70; G06T 2210/16; G06T 19/00; G06V 20/653; G06Q 30/0631; G06T 2207/30196; G06F 3/011

(57) ABSTRACT

Provided is an information processing apparatus including a shape information acquisition part configured to acquire three-dimensional shape data on a first article possessed by a user, a degree of similarity calculation part configured to calculate, by comparing the three-dimensional shape data on the first article with three-dimensional shape data on a plurality of second articles pre-stored in a database managed by an electronic commerce business operator, a degree of similarity between the first article and each of the second articles, a selection part configured to select the second article to be recommended to the user based on each of the degrees of similarity, and an output part configured to output, to the user, information on the second article selected.

### FIELD

The present disclosure relates to an information processing apparatus, an information processing method, and a program.

### BACKGROUND

In recent years, many users have increasingly purchased products such as clothing not from real stores but from electronic commerce (EC) business operators. In such a case, since a user cannot try on clothing to be purchased, the user refers to a size displayed on an EC site or the like to check if the clothing fits the user's body, and the like, and determines whether to purchase the clothing.

### CITATION LIST

### Patent Literature

Patent Literature 1: JP 2013-101468 A

### Non Patent Literature

Non Patent Literature 1: ZOZOSUIT (registered trademark), Internet <URL: http://zozo.jp/zozosuit/>

### SUMMARY

### Technical Problem

However, even when the user selects and purchases clothing having an appropriate size, the clothing actually sent may not fit the user's body such as an arm circumference, a shoulder width, a neck circumference, or a thigh circumference when the user wears the clothing. In such a case, the user immediately goes through a return procedure, or gives up and decides to continue wearing the clothing that does not fit his/her body, or the like. Therefore, allowing clothing having an appropriate size to be easily selected even at the EC site leads to preventing the user from suffering such an inconvenience as described above, and thus can be said to be an important factor in promoting sales at the EC site.

The present disclosure therefore proposes a novel and improved information processing apparatus, information processing method, and program allowing clothing having an appropriate size to be easily selected even at an EC site.

### Solution to Problem

According to the present disclosure, an information processing apparatus is provided that includes: a shape information acquisition part configured to acquire three-dimensional shape data on a first article possessed by a user; a degree of similarity calculation part configured to calculate, by comparing the three-dimensional shape data on the first article with three-dimensional shape data on a plurality of second articles pre-stored in a database managed by an electronic commerce business operator, a degree of similarity between the first article and each of the second articles; a selection part configured to select the second article to be recommended to the user based on each of the degrees of similarity; and an output part configured to output, to the user, information on the second article selected.

Moreover, according to the present disclosure, an information processing method is provided that includes: acquiring three-dimensional shape data on a first article possessed by a user; calculating, by comparing the three-dimensional shape data on the first article with three-dimensional shape data on a plurality of second articles pre-stored in a database managed by an electronic commerce business operator, a degree of similarity between the first article and each of the second articles; selecting the second article to be recommended to the user based on each of the degrees of similarity; and outputting, to the user, information on the second article selected.

Furthermore, according to the present disclosure, a program is provided that causes a computer to execute functions of: acquiring three-dimensional shape data on a first article possessed by a user; calculating, by comparing the three-dimensional shape data on the first article with three-dimensional shape data on a plurality of second articles pre-stored in a database managed by an electronic commerce business operator, a degree of similarity between the first article and each of the second articles; selecting the second article to be recommended to the user based on each of the degrees of similarity; and outputting, to the user, information on the second article selected.

### BRIEF DESCRIPTION OF DRAWINGS

FIG. 1 is an explanatory diagram for describing an example of a configuration of an information processing system 10 according to an embodiment of the present disclosure.

FIG. 2 is a block diagram illustrating a functional configuration of a server 100 according to the embodiment.

FIG. 3 is a flowchart (part 1) for describing an example of an information processing method according to the embodiment.

FIG. 4 is a flowchart (part 2) for describing an example of the information processing method according to the embodiment.

FIG. 5 is an explanatory diagram (part 1) for describing an example of a display according to the embodiment.

FIG. 6 is an explanatory diagram (part 2) for describing an example of the display according to the embodiment.

FIG. 7 is an explanatory diagram (part 1) for describing a first modification of the embodiment.

FIG. 8 is an explanatory diagram (part 2) for describing the first modification of the embodiment.

FIG. 9 is an explanatory diagram (part 3) for describing the first modification of the embodiment.

FIG. 10 is an explanatory diagram for describing a second modification of the embodiment.

FIG. 11 is an explanatory diagram (part 1) for describing a sixth modification of the embodiment.

FIG. 12 is an explanatory diagram (part 2) for describing the sixth modification of the embodiment.

FIG. 13 is an explanatory diagram illustrating an example of a hardware configuration of an information processing apparatus 900 according to the embodiment.

### DESCRIPTION OF EMBODIMENTS

Hereinafter, a preferred embodiment of the present disclosure will be described in detail with reference to the accompanying drawings. Note that, in the present specification and the drawings, components having substantially the same functional configurations are denoted by the same reference characters to avoid the description from being redundant.

Further, in the present specification and the drawings, a plurality of components having substantially the same or similar functional configurations may be denoted by the same reference characters suffixed with different numbers for the sake of identification. Note that when it is not particularly necessary to identify each of the plurality of components having substantially the same or similar functional configurations, the plurality of components are denoted by only the same reference characters. Further, components similar between different embodiments may be denoted by the same reference characters suffixed with different alphabets for the sake of identification. Note that when it is not particularly necessary to identify each of the similar components, the similar components are denoted by only the same reference characters.

Note that, in the following description, a person who uses a service provided according to the following embodiment of the present disclosure is referred to as a user.

Note that the description will be given in the following order.
1. Background of devising embodiment according to present disclosure
2. Embodiment
   2.1 Overview of information processing system 10 according to embodiment of present disclosure
   2.2 Functional configuration of server 100
   2.3 Information processing method
3. Modification
   3.1 First modification
   3.2 Second modification
   3.3 Third modification
   3.4 Fourth modification
   3.5 Fifth modification
   3.6 Sixth modification
4. Summary
5. Hardware configuration
6. Supplemental remarks

### 1. Background of Devising Embodiment According to Present Disclosure

First, before describing the embodiment according to the present disclosure, the background of devising the embodiment according to the present disclosure by the present inventors will be described.

As described above, in recent years, it is becoming common for many users to purchase products such as clothing not from real stores but from EC business operators. In such a case, since a user cannot try on clothing to be purchased, the user refers to a size of the clothing displayed on an EC site or the like to check if the clothing fits the user's body, and determines whether to purchase the clothing. Specifically, a typical method for the user to determine whether the clothing fits his/her body includes, for example, referring to a size standard attached to the clothing (for example, a small size, a medium size, a large size, any other size, or the like).

However, even when the user selects and purchases clothing having an appropriate size with reference to such a size standard as described above, the clothing actually sent may not fit the user's body such as an arm circumference, a shoulder width, a neck circumference, or a thigh circumference when the user wears the clothing. Then, in such a case, the user may have no choice but to immediately go through a troublesome return procedure, give up and decide to continue wearing the clothing that does not fit his/her body, or give up and put away the clothing in a closet. That is, since it is difficult to easily select clothing having an appropriate size at the time of purchase of clothing at the EC site, there are not a few cases where the user suffers various inconveniences.

Therefore, in view of the above-described circumstances, the present inventors have considered that enabling users to easily select clothing having an appropriate size even at the EC site is an important factor in promoting sales at the EC site, and have come up with the following mechanism to be implemented on the EC site. More specifically, the present inventors have considered that it is effective to implement, on the EC site, a mechanism that allows users to easily acquire his/her detailed size information (for example, a size such as an arm circumference, a shoulder width, a neck circumference, or a thigh circumference) in advance and compare the acquired detailed size information with the size of clothing that is a purchase candidate on the EC site.

One of the recent trends is the use of ZOZOSUIT (registered trademark) disclosed in Non Patent Literature 1 as a method under which a user can acquire his/her detailed size information in advance. The ZOZOSUIT is a stretchable whole body tights to which markers are attached and is a device capable of acquiring detailed size information on a user such as an arm circumference and shoulder width in advance by imaging and analyzing the user wearing the ZOZOSUIT with an imaging device. Then, the user can determine whether the clothing on the EC site fits his/her body by comparing the detailed size information acquired using the ZOZOSUIT with the size of the clothing on the EC site.

The above-described method, however, requires the user to obtain, in order to acquire the detailed size information, a dedicated large-scale device such as the above-described ZOZOSUIT and perform a troublesome operation. Therefore, from the viewpoint of use by various users (children, elderly people, or the like), it is difficult to say that the ZOZOSUIT can be easily used.

Therefore, in view of such circumstances, the present inventors have intensively conducted a study about development of an application that enables any user to easily select clothing having an appropriate size on an EC site and have devised the embodiment of the present disclosure accordingly. Specifically, the present disclosure proposes a mechanism capable of indirectly estimating detailed size information on a user on an EC site based on a size of clothing (three-dimensional shape data) already possessed by the user and comparing the detailed size information with a size of clothing that is a purchase candidate on the EC site. Hereinafter, details of the embodiment of the present disclosure devised by the present inventors will be sequentially described.

Note that, in the following description, an article (first article, second article) to be a target according to the embodiment of the present disclosure will be described as clothing, but the article according to the present embodiment is not limited to clothing and is not particularly limited as long as the article is an article such as furniture or a bag that can be traded with an EC business operator.

### 2. Embodiment

<2.1 Overview of Information Processing System 10 According to Embodiment of Present Disclosure>

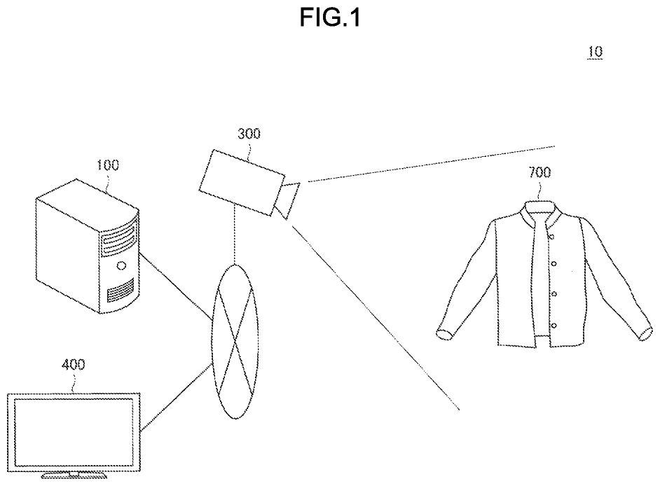

First, an overview of an information processing system (information processing apparatus) 10 according to the embodiment of the present disclosure will be described with reference to FIG. 1. FIG. 1 is an explanatory diagram for describing an example of a configuration of the information processing system 10 according to the present embodiment. As illustrated in FIG. 1, the information processing system 10 according to the present embodiment primarily includes a server 100, a camera 300, and an output device 400. Such components are communicatively connected to each other over a network. Specifically, the server 100, the camera 300, and the output device 400 are connected to the network via a base station or the like (not illustrated) (for example, a base station for mobile phones, an access point of a wireless local area network (LAN), or the like). Note that a communication system applied to the network may be any communication system regardless of wired or wireless communication (for example, WiFi (registered trademark), Bluetooth (registered trademark), or the like), but it is desirable to use a communication system capable of maintaining a stable operation. A description will be given below of each device included in the information processing system 10 according to the present embodiment.

(Server 100)

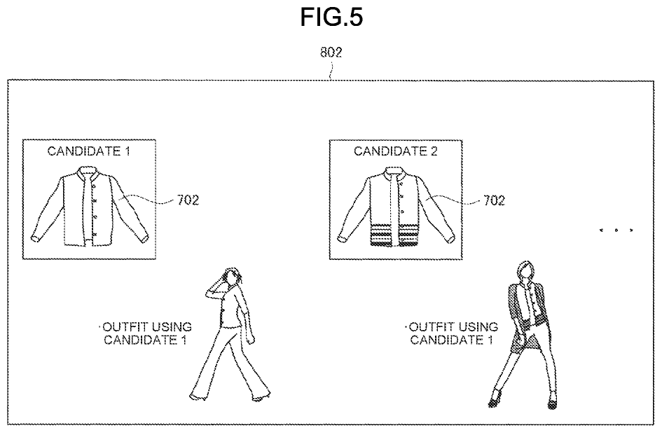

The server 100 acquires three-dimensional shape data on owned clothing (first article) (hereinafter, referred to as possessed clothing) 700, and outputs, as recommended clothing to the user, clothing 702 (second article) similar to the possessed clothing 700 among a plurality of pieces of clothing 702 (see FIG. 5) pre-stored in a database managed by an EC business operator (hereinafter, also referred to as an EC site) based on the three-dimensional shape data thus acquired. The server 100 is implemented by hardware such as a central processing unit (CPU), a read only memory (ROM), and a random access memory (RAM). Note that details of the server 100 will be described later.

(Camera 300)

Although only one camera 300 is illustrated in FIG. 1, the information processing system 10 according to the present embodiment may include two types of cameras: a time of flight (TOF) camera (TOF sensor) and a color camera, for example. Further, according to the present embodiment, a single camera 300 may have capabilities corresponding to the two types of cameras including the TOF camera and the color camera, but is not particularly limited. Details of such cameras will be described below.

—TOF Camera—

The TOF camera acquires three-dimensional shape data on the possessed clothing (first article) 700. Specifically, the TOF camera projects, to the possessed clothing 700, irradiation light such as infrared light and detects reflected light reflected off a surface of the possessed clothing 700. Then, the TOF camera calculates a phase difference between the irradiation light and the reflected light based on sensing data obtained through the detection of the reflected light to acquire distance information on (depth of) the possessed clothing 700, so that the three-dimensional shape data on the possessed clothing 700 can be acquired. Note that a method for acquiring the distance information based on the phase difference as described above is referred to as indirect TOF. Further, according to the present embodiment, direct TOF capable of acquiring the distance information on the possessed clothing 700 by measuring a light round trip time from when the irradiation light is emitted until when the irradiation light reflected off the possessed clothing 700 is received as the reflected light.

Further, according to the present embodiment, instead of the TOF camera described above, a projection imaging device that measures the distance to the possessed clothing 700 by structured light may be used. The structured light is the process of projecting a predetermined light pattern onto the surface of the possessed clothing 700 and analyzing deformation of the light pattern thus projected to estimate the distance to the possessed clothing 700. Further, according to the present embodiment, a stereo camera may be used instead of the TOF camera.

—Color Camera—

The color camera is capable of acquiring color information on color and pattern of the possessed clothing 700. Specifically, the color camera can include an imaging element (not illustrated) such as a complementary MOS (CMOS) image sensor, and a signal processing circuit (not illustrated) that performs imaging signal processing on a signal that results from photoelectric conversion made by the imaging element. Furthermore, the color camera can further include an optical system mechanism (not illustrated) including an imaging lens, a diaphragm mechanism, a zoom lens, a focus lens, and the like, and a drive system mechanism (not illustrated) that controls the motion of the optical system mechanism. Then, the imaging element collects incident light from the possessed clothing 700 as an optical image, and the signal processing circuit performs, on a pixel-by-pixel basis, photoelectric conversion on the optical image thus formed, reads a signal of each pixel as an imaging signal, and performs image processing, so that a captured image of the possessed clothing 700 can be acquired. Therefore, according to the present embodiment, the color information on the color and pattern of the possessed clothing 700 can be acquired through analysis of the captured image of the possessed clothing 700 thus acquired.

Note that, in FIG. 1, the camera 300 is illustrated as a single device, but the present embodiment is not limited to such a configuration, and the camera 300 may be built into, for example, a smartphone or a tablet personal computer (PC) carried by the user. Further, when the camera 300 is built into a smartphone, the smartphone may be fixed near the user by a fixing device (for example, a stand or the like).

(Output Device 400)

The output device 400 is a device configured to output, to the user, recommended clothing and is implemented by, for example, a display or the like as illustrated in FIG. 1. Note that the display may be built into, for example, a smartphone or a tablet PC carried by the user. Furthermore, the output device 400 may be a projection device capable of superimposing and displaying an object based on the recommended clothing on a real space as augmented reality (AR). Such a projection device may be, for example, a smart glass-type wearable device (not illustrated) worn in front of the eyes of a consulter. The smart glass-type wearable device is provided with a transmissive display, and the transmissive display uses, for example, a half mirror or a transparent light guide plate to hold a virtual image optical system including a transparent light guide part or the like in front of the eyes of the consulter and displays the object inside the virtual image optical system. Further, the projection device may be a head mounted display (HMD) mounted on the head of the consulter.

<2.2 Functional Configuration of Server 100>

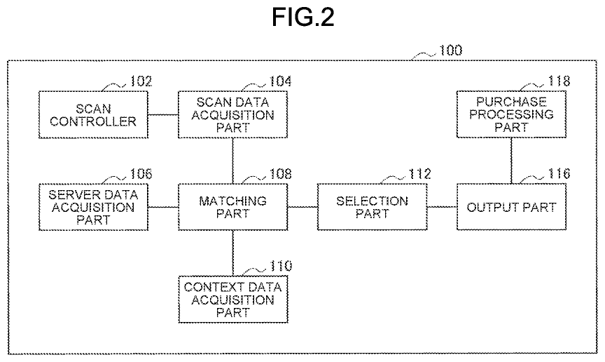

The overview of the information processing system 10 according to the present embodiment has been described above. Next, a description will be given of an example of a functional configuration of the server 100 according to the present embodiment with reference to FIG. 2. FIG. 2 is a block diagram illustrating a functional configuration of the server 100 according to the present embodiment. As illustrated in FIG. 2, the server 100 according to the present embodiment primarily includes, for example, a scan controller 102, a scan data acquisition part (shape information acquisition part, color information acquisition part) 104, a server data acquisition part 106, a matching part (degree of similarity calculation part) 108, a context data acquisition part 110, a selection part 112, an output part 116, and a purchase processing part 118. Hereinafter, details of each functional part of the server 100 according to the present embodiment will be described.

(Scan Controller 102)

The scan controller 102 controls the camera 300 to acquire the three-dimensional shape data, color information, and the like on the possessed clothing 700.

(Scan Data Acquisition Part 104)

The scan data acquisition part 104 acquires the three-dimensional shape data, color information, and the like on the possessed clothing 700 from the camera 300 and outputs the three-dimensional shape data, color information, and the like to the matching part 108 to be described later. Note that, according to the present embodiment, the three-dimensional shape data on the possessed clothing 700 may be, for example, a set of three-dimensional coordinates of each point on the surface of the possessed clothing 700, and a data format of the three-dimensional shape data is not particularly limited.

Specifically, according to the present embodiment, the three-dimensional shape data on the possessed clothing 700 may be composed of, for example, a combination of three-dimensional coordinates (an X coordinate, a Y coordinate, and a Z coordinate) and color information expressed as an RGB value, a decimal color code, a hexadecimal color code, or the like of each point on the surface of the possessed clothing 700. According to the present embodiment, the use of a format where the three-dimensional shape data on the possessed clothing 700 is expressed as a set of points indicated by three-dimensional coordinates directly acquired by the camera 300 allows a three-dimensional shape model of the possessed clothing 700 to be formed of planes defined by lines connecting each point. According to the present embodiment, when the three-dimensional shape data on the possessed clothing 700 is expressed using the three-dimensional coordinates and the like as described above, the shape of any clothing can be expressed as the three-dimensional shape model. However, when the three-dimensional coordinates are used, the amount of information may become huge, and in such a case, a load of data processing (matching or the like) and the like on the server 100 increases. Therefore, according to the present embodiment, when the three-dimensional coordinates are used, it is preferable that, in order to suppress an increase in the amount of information, an algorithm for thinning out the points expressed by the three-dimensional coordinates while maintaining information on the feature of the shape of the possessed clothing 700 be applied.

Further, according to the present embodiment, the three-dimensional shape data on the possessed clothing 700 may be composed of a set of pieces of attribute information on the color and shape of each part (for example, a neck, a front part, or the like) of the possessed clothing 700, each piece of the attribute information being expressed by numerical values or a defined pattern list (for example, shape preset or the like) like an extensible markup language (XML)-based format, for example. According to the present embodiment, when the three-dimensional shape data on the possessed clothing 700 is expressed by the markup language-based format as described above, an increase in the amount of information can be suppressed.

More specifically, when the markup language-based format as described above is used according to the present embodiment, first, an aggregate of three-dimensional coordinates of each point on the possessed clothing 700 is acquired from the camera 300, and the three-dimensional shape model of the possessed clothing 700 is created from the aggregate. Next, when the above-described markup language-based format is used, a standard model of typical clothing prepared in advance is assigned to the three-dimensional shape model thus created to identify each part of the possessed clothing 700 and extract the attribute information on the shape and color of the part thus identified, so that the three-dimensional shape data on the possessed clothing 700 can be expressed by the markup language-based format. Note that, according to the present embodiment, machine learning may be applied to the identification of each part as described above. Specifically, according to the present embodiment, three-dimensional shape models of various pieces of clothing, information on (label of) each part, and the like may be input to, for example, a learner provided in the server 100 to cause the learner to perform machine learning in advance. More specifically, for example, it is assumed that the server 100 includes a supervised learner such as support-vector regression or a deep neural network. Then, inputting the three-dimensional shape model of the clothing and the information on each part to the learner as an input signal and a training signal (label) causes the learner to perform machine learning on relations between these pieces of information in accordance with a predetermined rule, so that a database of the relations between the pieces of information can be built in advance. Furthermore, according to the present embodiment, each part of the possessed clothing 700 can be identified by consulting the database.

(Server Data Acquisition Part 106)

The server data acquisition part 106 acquires, from the database managed by the EC business operator (EC site), the three-dimensional shape data, color information, and the like on each of the plurality of pieces of clothing 702 pre-stored in the database, and outputs the three-dimensional shape data, the color information, and the like to the matching part 108 to be described later.

(Matching Part 108)

The matching part 108 calculates a degree of similarity between the possessed clothing 700 and each of the plurality of pieces of clothing 702 based on the three-dimensional shape data and color information on the possessed clothing 700 output from the scan data acquisition part 104 and the three-dimensional shape data and color information on each of the plurality of pieces of clothing 702 output from the server data acquisition part 106. Further, the matching part 108 outputs each degree of similarity thus calculated to the selection part 112 to be described later.

Specifically, the matching part 108 creates the three-dimensional shape model of the possessed clothing 700 based on the three-dimensional shape data on the possessed clothing 700 acquired from the scan data acquisition part 104, and further creates, by retopology, a polygon mesh model representing the three-dimensional shape of the possessed clothing 700. Note that, according to the present embodiment, it is preferable that protrusions (for example, burrs) unnecessary for expressing the three-dimensional shape of the possessed clothing 700 be removed in advance from the three-dimensional shape model. Furthermore, according to the present embodiment, it is preferable that the number of vertices of the polygon mesh be changed as needed.

Further, the matching part 108 creates, based on the three-dimensional shape data on the plurality of pieces of clothing 702 acquired from the server data acquisition part 106, a polygon mesh model representing the three-dimensional shape of each piece of clothing 702 in the same manner as described above. Furthermore, the matching part 108 deforms (enlarges or reduces) each part of the polygon mesh of each piece of clothing 702 so as to make as small as possible a difference between the polygon mesh model thus created representing the three-dimensional shape of the clothing 702 and the polygon mesh model representing the three-dimensional shape of the clothing 700. Such deformation allows the matching part 108 to obtain a degree of deformation of each part of the clothing 702, so that the matching part 108 can calculate a degree of similarity in shape by converting each degree of deformation into a score expressed in a predetermined form and adding up the scores thus converted.

Further, the matching part 108 may preliminarily narrow down the pieces of clothing 702 for which the degree of similarity is to be calculated, based on profile information on the user such as a purchase history, a wardrope, gender, age, or preference acquired from the context data acquisition part 110 to be described later. Furthermore, as described above, the matching part 108 may preliminarily narrow down the pieces of clothing 702 for which the degree of similarity is to be calculated, based on context information such as a season, weather, or schedule.

(Context Data Acquisition Part 110)

The context data acquisition part 110 is capable of acquiring context information on the user and outputting the context information to the matching part 108. Herein, the context information refers to, for example, information on an activity of the user or an environment around the user. For example, the context information may contain information on a category (indoor, outdoor), area, season, temperature, humidity, or the like of the environment around the user, information on a schedule of the user, or the like. Further, the context information may contain information on the profile information on the user (for example, gender, age, preference, purchase history, wardrope, or the like).

(Selection Part 112)

The selection part 112 selects clothing 702 to be recommended to the user from the database (EC site) based on each degree of similarity output from the matching part 108. For example, the selection part 112 can select a predetermined number of pieces of clothing 702 in descending order of degree of similarity in three-dimensional shape or select the predetermined number of pieces of clothing 702 in descending order of degree of similarity in color. Note that, according to the present embodiment, the selection part 112 may select clothing 702 similar in color to the clothing 700 or may select clothing 702 having a complementary color with respect to the color of the clothing 700, for example, and the clothing selected by the selection part 112 is not particularly limited. Then, the selection part 112 outputs information on the clothing 702 thus selected to the output part 116 to be described later.

Further, the selection part 112 may select the clothing 702 based on the profile information on the user such as a purchase history, wardrope, gender, age, or preference, or may select the clothing 702 based on profile information on another user similar in gender, age, or the like to the user. Furthermore, the selection part 112 may select the clothing 702 based on the context information such as a season, weather, or schedule.

(Output Part 116)

The output part 116 outputs the information on the clothing 702 selected by the selection part 112 to the user via the output device 400. Note that an example of the output form according to the present embodiment will be described later.

(Purchase Processing Part 118)

The purchase processing part 118 performs purchase processing on the clothing 702 in response to a selection operation made by the user on the clothing 702 output by the output part 116. Specifically, the purchase processing part 118 presents a purchase screen to the user and receives an input operation for the purchase processing from the user.

Note that, according to the present embodiment, the functional configuration of the server 100 is not limited to the example illustrated in FIG. 2, and may include, for example, other functional parts not illustrated in FIG. 2.

<2.3 Information Processing Method>

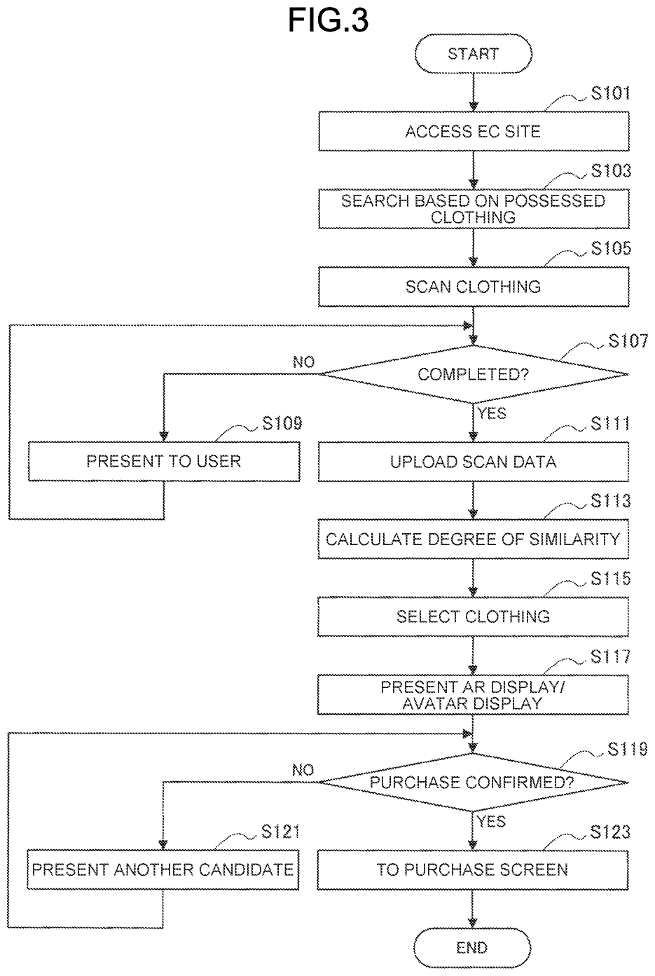

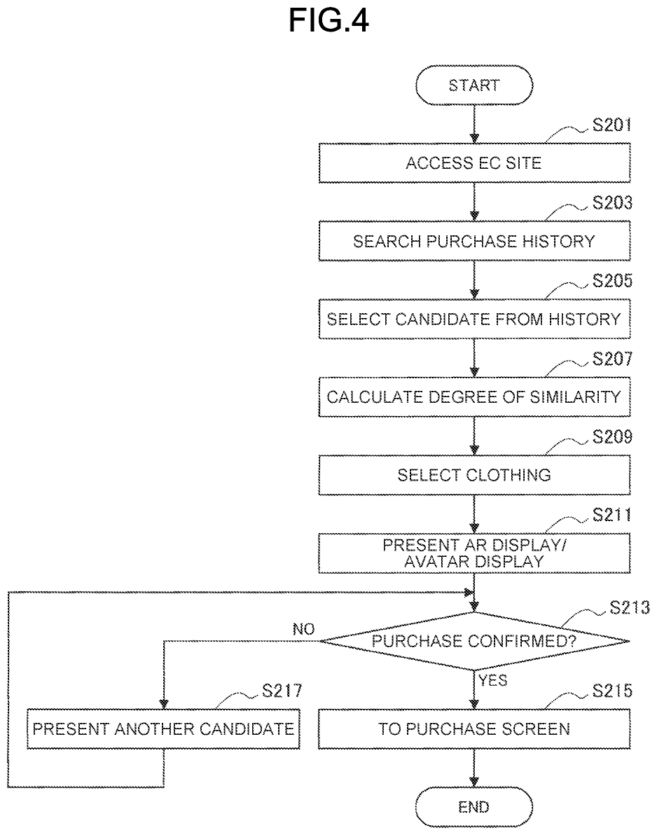

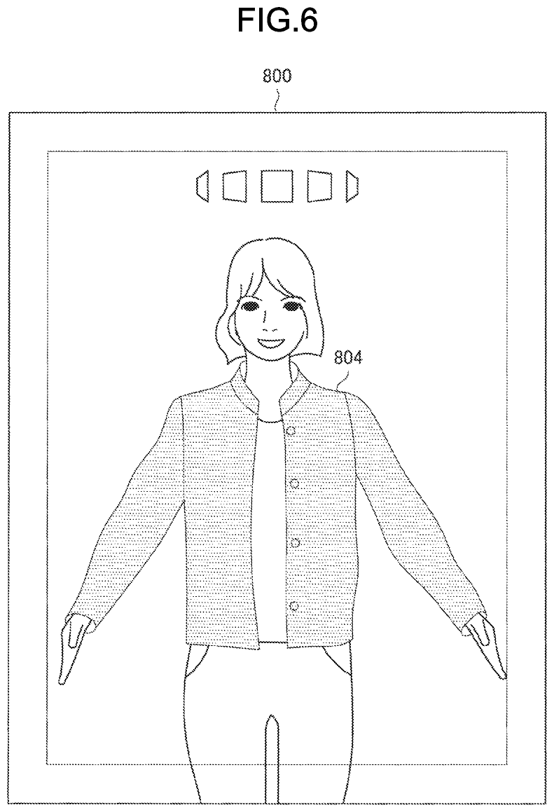

The information processing system 10 according to the present embodiment and the example of the functional configuration of the server 100 included in the information processing system 10 have been described in detail above. Next, a description will be given of an information processing method according to the present embodiment with reference to FIGS. 3 to 6. FIGS. 3 and 4 are flowcharts for describing an example of the information processing method according to the present embodiment. FIGS. 5 and 6 are explanatory diagrams for describing an example of a display according to the present embodiment.

Note that, according to the present embodiment, there are mainly two cases: a case (scan case) where after the three-dimensional shape data on the possessed clothing 700 of the user is acquired, the clothing 702 is recommended to the user based on the three-dimensional shape data thus acquired, and a case (purchase history case) where the clothing 702 is recommended to the user based on the purchase history of the user. Therefore, in the following description, information processing methods applied to the two cases will be sequentially described.

(Scan Case)

First, a description will be given of the case (scan case) where after the three-dimensional shape data on the possessed clothing 700 of the user is acquired, the clothing 702 is recommended to the user based on the three-dimensional shape data thus acquired. Specifically, the scan case according to the present embodiment can be executed by acquiring (scanning) the three-dimensional shape data on the possessed clothing 700 already possessed by the user and uploading the data to the server 100 when the user considers purchase of clothing using the EC site. Furthermore, in the scan case, the server 100 extracts the clothing 702 similar in size or similar in shape, design, and color to the possessed clothing 700 from the EC site by matching, and recommends the clothing 702 thus extracted to the user. More specifically, as illustrated in FIG. 3, the information processing method applied to the scan case according to the present embodiment includes a plurality of steps from Step S101 to Step S123. A description will be given below of details of each step included in the information processing method applied to the scan case.

—Step S101—

The server 100 receives an input operation indicating that the user has accessed the EC site.

—Step S103—

The server 100 receives an input operation indicating that the user has selected an item “search based on possessed clothing” on a user interface (UI) screen of the EC site.

—Step S105—

The user prepares the possessed clothing 700 possessed by the user at hand and scans the possessed clothing 700 using the camera 300. Note that, it is preferable to select, as the possessed clothing 700 to be scanned, clothing that is as similar as possible to the clothing that the user is considering purchase of. That is, for example, in a case where the user intends to purchase a shirt, it is preferable that the possessed clothing 700 to be scanned be a dress shirt, a T-shirt, a blouse, or the like.

Further, according to the present embodiment, when the possessed clothing 700 is scanned, the user may wear the possessed clothing 700, or may hang the possessed clothing 700 on a hanger or a stand, and how the possessed clothing 700 is displayed is not particularly limited.

Specifically, when the possessed clothing 700 worn by the user is scanned, it is preferable that the user spread his/her arms so as to avoid partial overlapping of the possessed clothing 700. Further, according to the present embodiment, when the possessed clothing 700 hung on a hanger is scanned, it is also preferable that the server 100 present, to the user, an explanation screen for guiding the user to hang the possessed clothing 700 on a hanger or the like in a suitable position so as to avoid partial overlapping of the possessed clothing 700 as described above.

—Step S107—

The server 100 determines whether the scanning of the possessed clothing 700 is completed, and when determining that the scanning is completed, the server 100 proceeds to Step S111 to be described later. When determining that the scanning is not yet completed, the server 100 proceeds to Step S109 to be described later.

—Step S109—

When the shape, size, or the like of a part of the possessed clothing 700 is unknown because, for example, the possessed clothing 700 hung on a hanger is folded at the time of scanning and the length of the sleeve is unknown, the server 100 presents, to the user, a fact that the server 100 has failed to accurately scan the possessed clothing 700 and a shape candidate created through estimation and interpolation. Specifically, the server 100 selects a plurality of candidates presumed to be similar to the possessed clothing 700 from among a plurality of shape candidates determined based on types of shapes of clothing categorized in advance in the server 100 and displays the candidates thus selected as thumbnails using a color similar to the color of the possessed clothing 700. Then, when the user selects a candidate considered to be the most similar to the possessed clothing 700 among the presented shape candidates, the server 100 can interpolate the part whose shape, size, or the like is unknown based on the shape candidate thus selected. Further, according to the present embodiment, when such interpolation based on the selection of a shape candidate is applied, a contribution ratio applied to the calculation of the degree of similarity of the interpolated part in a step to be described later may be lowered. Then, the server 100 returns to Step S107 described above.

—Step S111—

The server 100 uploads the three-dimensional shape data and color information (scan data) on the possessed clothing 700 obtained through the scanning.

—Step S113—

The server 100 calculates the degree of similarity in the size and detailed shape based on the three-dimensional shape data and the like created in advance based on measurement information on the clothing 702 to be purchased stored on the server 100 (EC site) and the three-dimensional shape data and the like uploaded in Step S111 described above.

According to the present embodiment, it is desirable that the degree of similarity be calculated for all the pieces of clothing 702 on the EC site; however, a huge number of calculation resources are required to calculate the degree of similarity for all the pieces of clothing 702. Therefore, according to the present embodiment, it is preferable to preliminarily narrow down pieces of clothing 702 for which the degree of similarity is to be calculated, based on the profile information on the user such as a purchase history, wardrope, gender, age, or preference. In addition, according to the present embodiment, narrowing down the pieces of clothing 702 for which the degree of similarity is to be calculated may be made based on the context information such as a season, weather, or schedule.

Furthermore, according to the present embodiment, the type of the possessed clothing 700 may be recognized based on the three-dimensional shape data on the possessed clothing 700 obtained through scanning, and only clothing 702 on the EC corresponding to the type thus recognized may be selected as clothing for which the degree of similarity is to be calculated. This makes it possible to suppress an increase in calculation resources used for calculating the degree of similarity according to the present embodiment.

—Step S115—

The server 100 selects a plurality of top-ranked pieces of clothing 702 in descending order of the degree of similarity based on the degree of similarity calculated in Step S113 described above. According to the present embodiment, the number of pieces of clothing to be selected is not particularly limited, but is preferably in a range from about 3 to 10, for example, and such a limitation allows the user to weigh the pieces of clothing 702 that are purchase candidates without experiencing difficulty of choice for a long time.

—Step S117—

The server 100 presents, to the user, a display of the pieces of information on the pieces of clothing 702 selected in Step S115 described above in descending order of the degree of similarity via the output device 400. For example, as illustrated in FIG. 5, the output device 400 displays a plurality of pieces of candidate clothing 702. At this time, as illustrated in FIG. 5, it is preferable that an outfit example using each piece of candidate clothing 702 (for example, a combination with other clothing or accessories) be displayed so as to allow the user to easily imagine a use case of the candidate clothing 702. Specifically, according to the present embodiment, the outfit example may be automatically displayed together with the information on the candidate clothing 702, or the outfit example may be displayed in response to the selection operation made by the user, and how the outfit example is displayed is not particularly limited. Further, according to the present embodiment, the outfit example to be displayed may be created by computer graphics (CG) rendering based on information on the pieces of clothing 702, accessories, and the like on the EC site, or alternatively, may be an image captured when the candidate clothing 702 is worn by a real person (fashion model), and how the outfit example is displayed is not particularly limited.

Furthermore, according to the present embodiment, when the user may select the candidate clothing 702 thus displayed, a virtual object 804 of the clothing 712 thus selected may be displayed using AR on the scanned clothing 700 present on the real space as illustrated in FIG. 6. Specifically, when the user wears the scanned clothing 700, the server 100 may display the virtual object of the clothing 702 on the image of the user wearing the clothing 700 so as to be superimposed on the clothing 700. Note that the above-described AR display can be made, for example, by holding a smartphone (not illustrated) provided with the camera 300 over the possessed clothing 700.

When the virtual object 804 is displayed in a superimposed manner as described above, the clothing 700 already worn by the user may extend out of the virtual object 804 because the clothing 700 is longer in body or sleeve than the clothing 700, resulting in an unnatural display. Therefore, according to the present embodiment, the body of the user, the clothing 700, and the background in the image are identified from each other by image processing, a part of the clothing 700 that looks extending out is displayed in the color of the background when the part is away from the body of the user and is displayed in the color of the body when the part is close to the body of the user, thereby realizing a more natural AR display. Furthermore, according to the present embodiment, a more natural AR display may be realized by deforming the virtual object 804 in accordance with the motion of the user.

Further, according to the present embodiment, the display is not limited to the AR display as described above, and, for example, an image where the selected clothing 702 is worn by an avatar (doll) prepared in advance on the EC site may be displayed. Specifically, according to the present embodiment, the physique and size of the avatar to be displayed may be determined based on information extracted from the three-dimensional shape data on the possessed clothing 700 or the like. Furthermore, according to the present embodiment, a face image of the user is registered in advance on the EC site, and the face image of the user or a three-dimensional shape model obtained based on the face image is pasted to the face part of the avatar, so as to display an image close to the image of the user actually wearing the clothing 702.

—Step S119—

The server 100 determines whether or not an input operation for selecting the purchase of the clothing 702 presented in Step S117 described above has been received. When determining that the input operation has been received, the server 100 proceeds to Step S123 to be described later. When determining that the input operation has not been received, the server 100 proceeds to Step S121 to be described later.

—Step S121—

The server 100 presents, to the user, a display of clothing 702 having the next highest degree of similarity via the output device 400.

—Step S123—

The server 100 presents, to the user, a purchase screen via the output device 400. Then, the user performs an operation on the purchase screen to conduct a purchase procedure on the clothing 702.

As described above, according to the present embodiment, the detailed size information on the user is indirectly estimated based on the three-dimensional shape data on the possessed clothing 700 already possessed by the user, and clothing 702 having a similar size and the like on the EC site can be automatically extracted by comparison with the information on the detailed size thus estimated. Therefore, according to the present embodiment, any user can easily select clothing having an appropriate size on the EC site.

(Purchase History Case)

According to the present embodiment, when the server 100 (EC site) pre-stores a purchase history of the user, three-dimensional shape data associated with clothing in the purchase history may be used. Therefore, a description will be given below of such a purchase history case. More specifically, as illustrated in FIG. 4, an information processing method applied to the purchase history case according to the present embodiment includes a plurality of steps from Step S201 to Step S217. A description will be given below of details of each step included in the information processing method applied to the purchase history case.

—Step S201—

The server 100 receives an input operation indicating that the user has accessed the EC site.

—Step S203—

The server 100 receives an input operation indicating that the user has selected an item “search based on purchase history” on the user interface (UI) screen of the EC site.

—Step S205—

The server 100 presents, to the user, a plurality of clothing type candidates determined based on clothing types categorized in advance in the server 100. Then, the user selects a clothing type candidate that the user is considering purchase from among the candidates thus presented, thereby allowing the server 100 to narrow down pieces of clothing 702 for which the degree of similarity is to be calculated.

—Step S207—

The server 100 calculates the degree of similarity in the size and detailed shape based on the three-dimensional shape data created in advance based on measurement information on the clothing 702 to be purchased stored on the server 100 (EC site) and three-dimensional shape data associated with clothing in the purchase history.

—From Step S209 to Step S215—

Step S209 to Step S215 are similar to Step S115 to Step S123 illustrated in FIG. 3 described above, and thus, no description will be given below of Step S209 to Step S215.

As described above, according to the present embodiment, the detailed size information on the user is indirectly estimated based on the three-dimensional shape data associated with clothing in the purchase history of the user, and clothing 702 having a similar size and the like on the EC site can be automatically extracted by comparison with the information on the detailed size thus estimated. Therefore, according to the present embodiment, any user can easily select clothing having an appropriate size on the EC site.

### 3. Modification

The details of the information processing method according to the embodiment of the present disclosure have been described above. Next, a description will be given of various modifications according to the embodiment of the present disclosure. Note that the following modifications are merely examples of the embodiment of the present disclosure, and the embodiment of the present disclosure is not limited to any one of the following examples.

<3.1 First Modification>

People have various physiques, and, for example, there are a person with a thick hip and a thin neck, a person with broad shoulders relative to a height, a person with a short neck and long arms, and the like. Needless to say that the users who use the embodiment of the present disclosure also have various physiques. Furthermore, a request regarding wearing comfort varies for each user, and there are various requests regarding wearing comfort such as a person who prefers loose-fitting around shoulders and a person who prefers close-fitting around a chest. Therefore, according to a first modification of the embodiment of the present disclosure to be described below, in order to respond to a request regarding various physiques and wearing comfort of the user with consideration given to a fit feeling to the body of the user for each part of clothing, the degree of similarity is calculated with a weight assigned to each part of the clothing.

More specifically, according to the present modification, for example, for a user with a thick neck or a user who emphasizes a fit feeling around a neck, a large weight is assigned to the degree of similarity regarding the neck as compared with the other parts, and the degree of similarity with the neck emphasized is calculated. Note that, according to the present modification, the degree of similarity is calculated with various weighting patterns applied without grasping in advance of which part on the clothing the user emphasizes a fit feeling, and the like, and pieces of clothing 702 high in degree of similarity among various patterns are recommended to the user, and the user selects one from among the pieces of clothing 702.

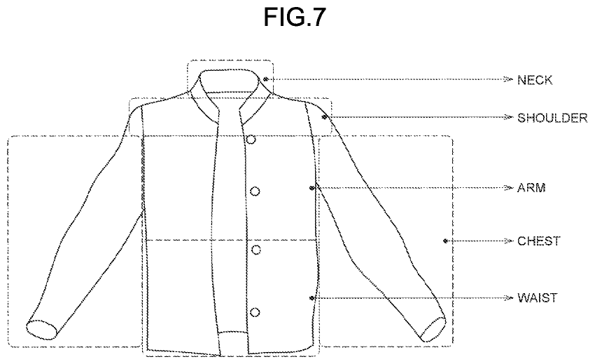

Therefore, a description will be given below of the first modification of the embodiment of the present disclosure with reference to FIGS. 7 to 9. FIGS. 7 to 9 are explanatory diagrams for describing the first modification.

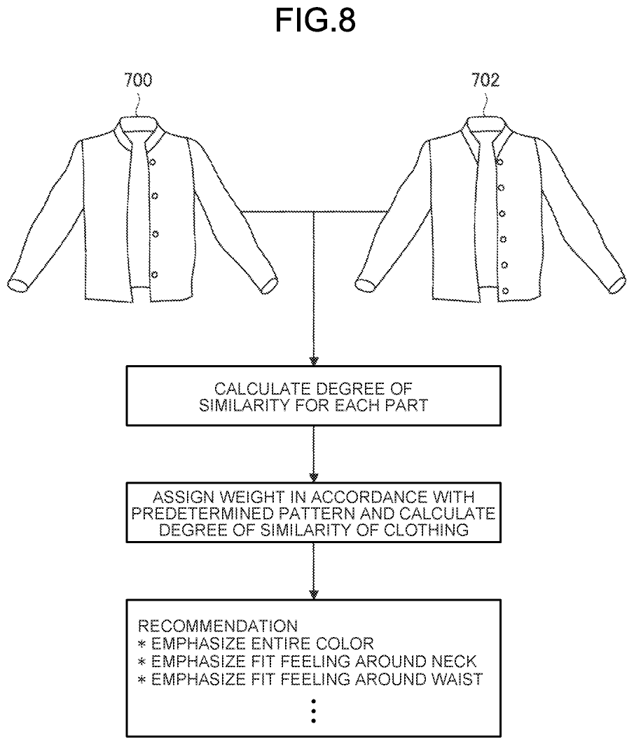

For example, according to the present modification, as illustrated in FIG. 7, clothing is divided into parts such as a neck, shoulders, arms, a chest, and a waist. Specifically, according to the present modification, as illustrated in FIG. 8, the degree of similarity between the possessed clothing 700 and each piece of clothing 702 is calculated for each of the parts. Next, the degree of similarity between the possessed clothing 700 and each piece of clothing 702 is calculated based on the calculation of the sum of the degrees of similarity of each, and according to the present modification, after various weighting patterns are applied, the sum of the degrees of similarity of each part is calculated. For example, as a pattern where a fit feeling around a neck is emphasized, the degree of similarity regarding the neck is assigned a large weight as compared with the other parts, and then the sum of the degrees of similarity of the parts is calculated. Further, for example, as a pattern where a fit feeling around a waist is emphasized, the degree of similarity regarding the waist is assigned a large weight as compared with the other parts, and then the sum of the degrees of similarity of each part is calculated. Furthermore, according to the present modification, as a pattern where an entire color is emphasized, a degree of similarity in entire color between the possessed clothing 700 and each piece of clothing 702 may be assigned a weight.

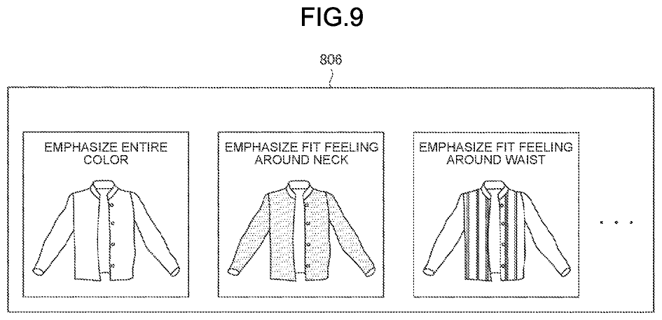

Then, according to the present modification, a plurality of pieces of clothing 702 are selected in descending order of degree of similarity for each pattern, and as illustrated in FIG. 9, pieces of clothing 702 recommended for each pattern (for example, a pattern where the entire color is emphasized, a pattern where a fit feeling around a neck is emphasized, a pattern where a fit feeling around a waist is emphasized, and the like) are displayed. Note that, according to the present modification, the above-described weighting pattern is not limited to a weighting pattern where only one part is assigned a large weight as compared with the other parts, and may be a weighting pattern where a plurality of parts are assigned a large weight as compared with the other parts, and details of the weighting pattern are not particularly limited.

As described above, according to the present modification, the degree of similarity is calculated with a weight assigned to each part of clothing in order to give consideration to a fit feeling to the body of the user for each part of the clothing, thereby making it possible to respond to various requests regarding physiques and wearing comfort of the user.

<3.2 Second Modification>

According to the above-described embodiment, when the user wears the possessed clothing 700 that has been scanned, for example, the virtual object of the clothing 702 is displayed on the image of the user wearing the possessed clothing 700 so as to be superimposed on the possessed clothing 700. Specifically, according to the present embodiment, the virtual object of the clothing 702 deformed so as to be superimposed on the possessed clothing 700 is displayed. The posture of the user or the like, however, may make the superimposed display of the virtual object 804 as described above unnatural. Therefore, according to the present modification, the skeletal frame and posture of the user are estimated through analysis of captured image of and three-dimensional shape data on the user, and the virtual object 804 of the clothing 702 is deformed in accordance with the estimation result and is then displayed in a superimposed manner. Furthermore, according to the present modification, deforming the virtual object 804 in accordance with the skeletal frame and posture of the user allows the virtual object 804 to portray creases or looseness that would occur when the user actually wears the clothing 702, and it thus is possible to realize a more natural AR display.

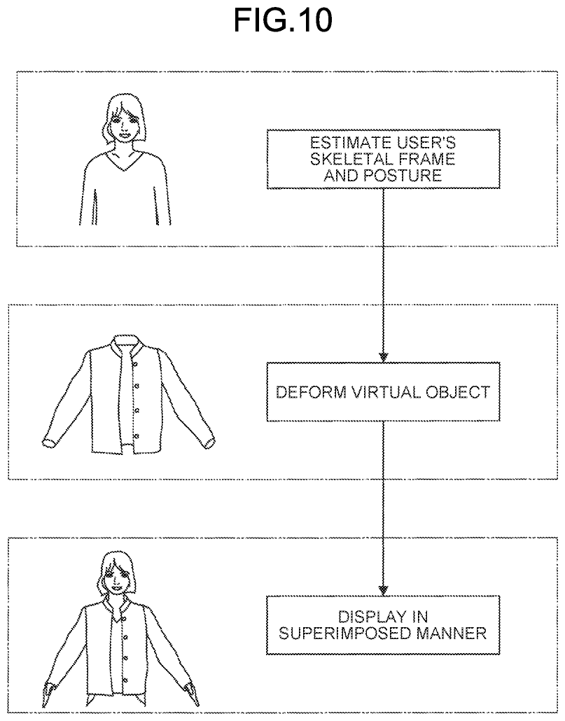

A description will be given below of a second modification of the embodiment of the present disclosure with reference to FIG. 10. FIG. 10 is an explanatory diagram for describing the second modification.

According to the present modification, as illustrated in FIG. 10, first, the skeletal frame and posture of the user are estimated. According to the present modification, for example, the captured image of and three-dimensional shape data (distance information) on the user are acquired by the camera 300 described above, and the skeletal frame (bone length, joint position, and the like) and posture of the user can be estimated through analysis of such pieces of information. Furthermore, according to the present modification, the skeleton (skeletal model) of the user may be estimated based on the skeletal frame and posture thus estimated, and a three-dimensional model of the body of the user may be estimated based on the skeleton that has been fleshed out.

Furthermore, according to the present modification, the three-dimensional model of the clothing 702 is deformed so as to match the three-dimensional model of the body of the user. At this time, deformation made by giving parameters such as weight, hardness, and elasticity (allowable degree of relative coordinate change with respect to surrounding points, magnitude of recovery force for eliminating the relative coordinate change, and the like) in advance to each point on the three-dimensional model of the clothing 702 deforms the three-dimensional model of the clothing 702, under the physical simulation condition, in accordance with the posture of the user. As described above, according to the present modification, it is possible to obtain the virtual object 804 that can portray creases or looseness that would occur when the user actually wears the clothing 702.

Then, according to the present modification, the virtual object 804 based on the three-dimensional model of the clothing 702 thus deformed is displayed so as to be superimposed on the body of the user. This allows, according to the present modification, the virtual object 804 of the clothing 702 to be more naturally displayed.

Note that, according to the present modification, physically simulating the shape of the three-dimensional model of the clothing 702 using the above-described method also allows the clothing 702 with the sleeves rolled up or the hem tied up at the front to be displayed using AR. Furthermore, according to the present modification, the color, brightness, and the like of the virtual object 804 may be changed in accordance with a detected state of light around the user.

Furthermore, according to the present modification, not only the virtual object 804 of the clothing 702 is displayed in accordance with the current skeletal frame, posture, and the like of the user, but also the virtual object 804 of the clothing 702 may be displayed in accordance with the future physique and the like of the user. This allows, according to the present modification, for example, a user who is diligent in getting him/her body into shape to consider purchase of the clothing 702 by imagining the user who has succeeded in getting him/her body into shape.

For example, according to the present modification, when the three-dimensional model of the body of the user is created, it is also possible to create, for example, a three-dimensional model of the body of the user who has got him/her body into shape by adjusting fleshiness, expansion and contraction of the limbs, the thickness of the trunk, and the like. Note that the adjustment amount of the three-dimensional model of the body of the user according to the present modification may be determined based on a database on an allowable range of changes in pixels on a predetermined color image, or may be determined based on an amount of change in appearance when the size of the clothing 702 is changed, and how the adjustment amount is determined is not particularly limited.

Further, when the three-dimensional model of the body of the user as described above is adjusted, a difference between the three-dimensional model thus adjusted and the three-dimensional model of the real body may increase. Therefore, according to the present modification, when the difference is large, and a void appears in the display image, filling processing may be performed using inpainting or the like, or when the user and a ground contact surface of the floor are misaligned, the drawing of the floor may be corrected.

Further, according to the present modification, when the difference between the adjusted three-dimensional model and the three-dimensional model of the real body becomes larger, the display using the avatar of the user may be presented instead of the superimposed display as described above. At this time, according to the present modification, wrinkles of the face part of the avatar may be removed, parts (nose, eyes, and the like) may be deformed, or the parts may be enlarged or reduced.

<3.3 Third Modification>

According to the second modification described above, the virtual object 804 of the clothing 702 is deformed and displayed in accordance with the skeletal frame and posture of the user, but according to the present modification, a level of wearing comfort of the clothing 702 estimated based on information obtained at the time of the deformation is also presented to the user. Therefore, a description will be given below of a third modification of the embodiment of the present disclosure.

Specifically, according to the present modification, the wearing comfort is defined as being higher as the degree of catching, pressure, or the like felt when the user wears clothing and moves is smaller. Then, according to the present modification, information on a material property (material information) of each part of each piece of clothing 702 is pre-stored on the EC site (server 100). Then, according to the present modification, a wearing comfort level database where the material property and a corresponding part are associated with each other may be created in advance based on the information described above, and the wearing comfort of the clothing 702 may be quantified in advance by consulting the database.

Furthermore, according to the second modification described above, deformation made by giving parameters such as weight, hardness, and elasticity in advance to each point on the three-dimensional model of the clothing 702 deforms the three-dimensional model of the clothing 702, under the physical simulation condition, in accordance with the posture or motion of the user. Therefore, according to the present modification, a stress value or the like applied to each part can be acquired through physical simulation with reference to the material property of each part, and thus, the wearing comfort may be quantified based on the stress value or the like thus acquired. Furthermore, according to the present modification, the wearing comfort may be visualized and displayed using a color or an arrow based on the stress value of each part superimposed and displayed on each part of the virtual object 804 of the clothing 702.

Note that, since there is an individual difference in how to feel the wearing comfort, according to the present modification, a personal database that allows adjustments to numerical values in the wearing comfort level database prepared in advance for each user may be created. The numerical values in the personal database can be updated by feedback of evaluation of wearing comfort of clothing purchased in the past by the user himself/herself. At this time, as the updating method, the user himself/herself may identify a part and adjust the numerical value, and the feedback information on the evaluation of the wearing comfort of the entire clothing 702 evaluated by the user may be allocated in the order of the emphasized parts selected by the user according to the first modification.

As described above, according to the present modification, since the wearing comfort of the clothing 702 can also be presented to the user, the user can select the clothing 702 with reference to the wearing comfort 702.

<3.4 Fourth Modification>

According to the embodiment of the present disclosure, the clothing 702 to be recommended may be changed in accordance with the purchase history of the user or the preference of the user that varies in a manner that depends on the age. Therefore, a description will be given below of a fourth modification of the embodiment of the present disclosure.

Specifically, according to the present modification, when selecting and recommending the clothing 702 in accordance with the degree of similarity of the clothing 702 on the EC site described above or the preference of the user, a selection tendency of the clothing 702 to be recommended may be changed based on the purchase history of the user stored on the EC site or the feedback of the evaluation of the purchased clothing 702 from the user. Note that, according to the present modification, the selection tendency of the clothing 702 to be recommended may be changed in accordance with the profile information on the user such as the age, information such as a season, or the like. Furthermore, according to the present modification, the selection tendency of the clothing 702 to be recommended may be changed based on the profile information on another user who is identical or similar in gender, age, or the like to the user.

For example, when a fact that the preference of the user for clothing has changed to brighter colors with the lapse of time can be grasped through analysis or the like on the purchase history, according to the present modification, clothing 702 having a bright color as compared with the possessed clothing 700 is selected as the clothing to be recommended. Furthermore, when the feedback of the evaluation is directly obtained from the user, the server 100 may finely adjust a predicted content and predicted reflection intensity of the clothing 702 predicted to be selected by the user based on the feedback.

As described above, according to the present modification, changing the clothing 702 to be recommended in accordance with the preference that varies in a manner that depends on the purchase history or age of the user allows clothing 702 more suitable for the current preference or the like of the user to be recommended.

<3.5 Fifth Modification>

The three-dimensional shape data on the clothing 700 or the like of the present embodiment described above may be exchanged between EC business operators or between users. This allows, according to the fifth modification according to the embodiment of the present disclosure, the EC business operator or the user to accurately estimate detailed size information on or preference of the user or another user.

Further, according to the present modification, when the user puts secondhand clothing already worn by the user up for sale on the EC site, three-dimensional shape data on the clothing may be uploaded on the EC site in association with the secondhand clothing to be put up for sale. This allows, according to the present modification, another user who intends to purchase secondhand clothing to easily consider whether the clothing fits his/her body.

Furthermore, according to the present modification, a mechanism for transferring the three-dimensional shape data on the clothing together with the clothing every time the owner of the clothing changes may be provided. This allows, according to the present modification, the three-dimensional shape data on the clothing when the clothing was new and the three-dimensional shape data on the clothing already worn to become secondhand clothing to be compared with each other, allowing evaluation of the state of the secondhand clothing to be made with high accuracy.

Note that, according to the present modification, when the format of the three-dimensional shape data on the clothing is not unified, it is preferable that a mechanism for converting the format into a format common to EC sites be provided, for example.

<3.6 Sixth Modification>

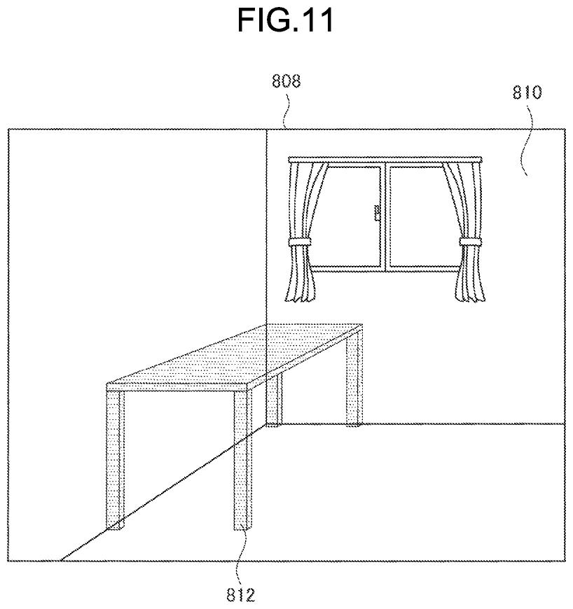

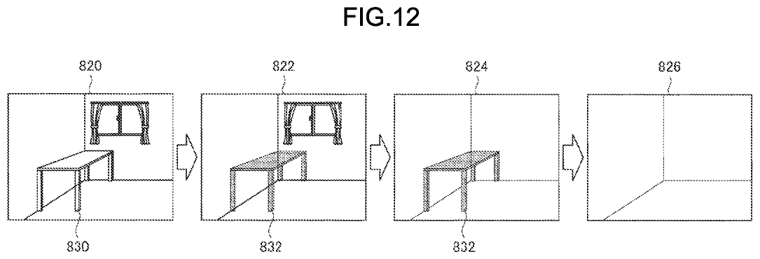

As described above, an article to be a target according to the embodiment of the present disclosure is not limited to clothing and is not particularly limited as long as the article is an article such as furniture that can be traded with an EC business operator. Therefore, a description will be given of a case where the present disclosure is applied to furniture as a sixth modification according to the embodiment of the present disclosure with reference to FIGS. 11 and 12. FIGS. 11 and 12 are explanatory diagrams for describing the sixth modification.

Specifically, as for furniture, it is possible to provide a database of three-dimensional shape data on an EC site, as with clothing. According to the present modification, the user scans furniture possessed by the user and uploads three-dimensional shape data and the like on the furniture on the EC site, so that the user can easily select furniture similar in size and the like to the furniture.

Further, according to the present modification, a screen 808 as illustrated in FIG. 11 may be displayed so that the user can easily imagine a case where the furniture selected on the EC site is arranged in a user's room. Specifically, the screen 808 is a screen where a virtual object 812 of the furniture selected on the EC site is displayed using AR in an image of a room 810 that is a real space so as to be superimposed on furniture that is present in the real space and is to be scanned.

Furthermore, according to the present modification, information on corners, floor surface, and wall surface of the room 810 can be acquired by junction detection with respect to the captured image of the room 810. Then, according to the present modification, the use of such information makes it possible to display only the outer shape of the room 810 and the target furniture by removing all but the target furniture or display only the outer shape of the room 810, so that the user can more clearly imagine the state in the room 810 after the furniture is purchased.

Specifically, according to the present modification, as illustrated in FIG. 12, an image 820 representing a state where furniture 830 to be scanned is installed in the room 810 that is the real space and an image 822 representing a state where a virtual object 832 of the target furniture selected on the EC site is displayed in the room 810 that is the real space may be displayed for the user. Furthermore, according to the present modification, an image 824 representing a state where all but the virtual object 832 is removed, and the virtual object 832 and the outer shape of the room 810 are displayed, and an image 826 representing a state where only the outer shape of the room 810 is displayed may be displayed. Note that, according to the present modification, switching between the above-described four state images can be made by using a check box or a slider.

Further, according to the present modification, when the virtual object 812 of the target furniture does not fit well on the screen due to a capturing position or angle of the user, or when the capturing position is too close to transmit an image of the room in which the target furniture is arranged, it is preferable to guide the user to readjust the capturing position or angle.

### 4. Summary

As described above, according to the present embodiment, the detailed size information on the user is indirectly estimated based on the three-dimensional shape data on the possessed clothing 700 already possessed by the user, and clothing 702 having a similar size and the like on the EC site can be automatically extracted by comparison with the information on the detailed size thus estimated. Therefore, according to the present embodiment, any user can easily select clothing having an appropriate size on the EC site.

### 5. Hardware Configuration

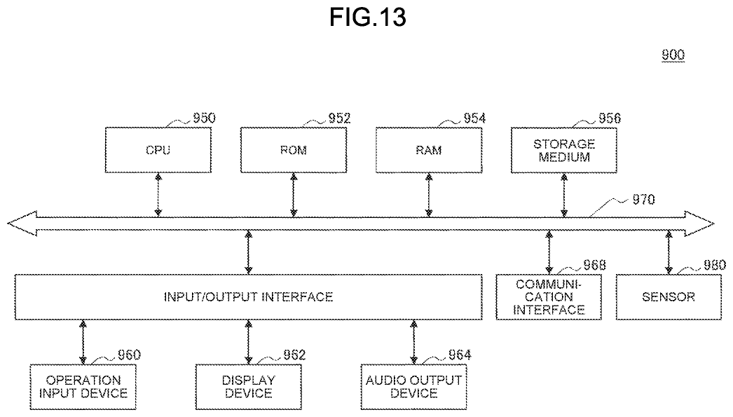

FIG. 13 is an explanatory diagram illustrating an example of a hardware configuration of an information processing apparatus 900 according to the present embodiment. In FIG. 13, the information processing apparatus 900 corresponds to an example of the hardware configuration of the server 100 described above.

The information processing apparatus 900 includes, for example, a central processing unit (CPU) 950, a read only memory (ROM) 952, a random access memory (RAM) 954, a recording medium 956, and an input/output interface 958. The information processing apparatus 900 further includes an operation input device 960, a display device 962, an audio output device 964, a communication interface 968, and a sensor 980. Further, the information processing apparatus 900 has the components connected over, for example, a bus 970 serving as a data transmission line.

(CPU950)

The CPU 950 serves as a main controller that includes, for example, one or more processors including an arithmetic circuit such as a CPU, various processing circuits, and the like and controls the entirety of the information processing apparatus 900.

(ROM 952 and RAM 954)

The ROM 952 stores control data, such as a program and an operation parameter, used by the CPU 950. The RAM 954 temporarily stores, for example, a program to be executed by the CPU 950.

(Recording Medium 956)

The recording medium 956 stores, for example, various pieces of data such as data on the information processing method according to the present embodiment and various applications. Herein, examples of the recording medium 956 include a magnetic recording medium such as a hard disk, and a nonvolatile memory such as a flash memory. Further, the recording medium 956 may be removable from the information processing apparatus 900.

(Input/Output Interface 958, Operation Input Device 960, Display Device 962, and Audio Output Device 964)

The input/output interface 958 connects, for example, the operation input device 960, the display device 962, the audio output device 964, and the like. Examples of the input/output interface 958 include a universal serial bus (USB) terminal, a digital visual interface (DVI) terminal, a high-definition multimedia interface (HDMI) (registered trademark) terminal, various processing circuits, and the like.

The operation input device 960 serves as, for example, a data input device and is connected to the input/output interface 958 inside the information processing apparatus 900. Examples of the operation input device 960 include a button, a direction key, a rotary selector such as a jog dial, a touchscreen, and a combination of such devices.

The display device 962 is, for example, provided on the information processing apparatus 900 and is connected to the input/output interface 958 inside the information processing apparatus 900. Examples of the display device 962 include a liquid crystal display, an organic electro-luminescence (EL) display, and the like.

The audio output device 964 is, for example, provided on the information processing apparatus 900 and is connected to the input/output interface 958 inside the information processing apparatus 900. Examples of the audio output device 964 include a speaker, headphones, and the like.

Note that it goes without saying that the input/output interface 958 is connectable to an external device such as an operation input device (for example, a keyboard, a mouse, or the like) or a display device provided outside the information processing apparatus 900.

(Communication Interface 968)

The communication interface 968 is a communication means included in the information processing apparatus 900 and serves as a communication part (not illustrated) for establishing radio or wired communication with an external device over a network (not illustrated) (or directly). Herein, examples of the communication interface 968 include a communication antenna and a radio frequency (RF) circuit (radio communication), an IEEE 802.15.1 port and a transceiver circuit (radio communication), an IEEE 802.11 port and a transceiver circuit (radio communication), and a local area network (LAN) terminal and a transceiver circuit (wired communication).

(Sensor Part 980)

The sensor 980 is various sensors that serve as the above-described camera 300 and the like.

Further, for example, the information processing apparatus 900 need not include the communication interface 968 when the information processing apparatus 900 is configured to communicate with an external device and the like via a connected external communication device or the information processing apparatus 900 is configured to operate on a standalone basis. Further, the communication interface 968 may be capable of communicating with one or more external devices in accordance with a plurality of communication systems.

Further, the information processing apparatus according to the present embodiment may be applied to a system including a plurality of apparatuses that need to connect to a network (or need to establish communication with each other), such as cloud computing. That is, the information processing apparatus according to the present embodiment described above can also be implemented as an information processing system that performs processing related to the information processing method according to the present embodiment by using a plurality of apparatuses, for example.

An example of the hardware configuration of the information processing apparatus 900 has been described above. Each of the above-described components may be implemented by a general-purpose component, or may be implemented by hardware tailored to the function of the component. Such a configuration may be changed as needed in accordance with a technical level at the time of implementation.

### 6. Supplemental Remarks

Note that the embodiment of the present disclosure described above may include, for example, a program for causing a computer to function as the information processing apparatus according to the present embodiment, and a non-transitory tangible medium where a program is recorded. Further, the program may be distributed over a communication line such as the Internet (including radio communication).

Further, each step of the processing according to the embodiment of the present disclosure described above need not necessarily be executed in the described order. For example, each step may be executed in a suitably changed order. Further, some of the steps may be executed in parallel or individually, instead of being executed in time series. Furthermore, the processing method of each step need not necessarily be executed in accordance with the described method, and may be executed by another functional part in accordance with another method, for example.

Although the preferred embodiment of the present disclosure has been described in detail with reference to the accompanying drawings, the technical scope of the present disclosure is not limited to such examples. It is obvious that those ordinarily skilled in the art of the present disclosure can conceive various changes or modifications within the scope of the technical idea set forth in the claims, and it should be understood that such changes or modifications also naturally fall within the technical scope of the present disclosure.

Further, the effects described herein are merely illustrative or exemplary effects and are not restrictive. That is, the technology according to the present disclosure can exhibit other effects obvious to those skilled in the art from the description given herein together with or instead of the above-described effects.

Note that the following configurations also fall within the technical scope of the present disclosure.

(1)

An information processing apparatus comprising:

a shape information acquisition part configured to acquire three-dimensional shape data on a first article possessed by a user;

a degree of similarity calculation part configured to calculate, by comparing the three-dimensional shape data on the first article with three-dimensional shape data on a plurality of second articles pre-stored in a database managed by an electronic commerce business operator, a degree of similarity between the first article and each of the second articles;

a selection part configured to select the second article to be recommended to the user based on each of the degrees of similarity; and

an output part configured to output, to the user, information on the second article selected.

(2)

The information processing apparatus according to (1), wherein

the shape information acquisition part acquires the three-dimensional shape data on the first article from a TOF sensor configured to project light to the first article and detect the light to acquire the three-dimensional shape data on the first article.

(3)

The information processing apparatus according to (1) or (2), further comprising a color information acquisition part configured to acquire color information on a color of the first article.

(4)

The information processing apparatus according to (3), wherein

the degree of similarity calculation part calculates, by comparing the color information on the first article with the color information on the plurality of second articles, the degree of similarity between the first article and each of the second articles.

(5)

The information processing apparatus according to any one of (1) to (4), wherein

the degree of similarity calculation part calculates the degree of similarity between identical parts among a plurality of parts of the first article and a plurality of parts of each of the second articles.

(6)

The information processing apparatus according to (5), wherein

the degree of similarity calculation part

sequentially calculates the degree of similarity between each set of the identical parts of the first article and each of the second articles and

weights the degree of similarity calculated.

(7)

The information processing apparatus according to any one of (1) to (6), wherein

the selection part selects the second article in descending order of the degree of similarity.

(8)

The information processing apparatus according to any one of (1) to (7), wherein

the selection part selects the second article based on profile information on the user.

(9)

The information processing apparatus according to (8), wherein

the selection part selects the second article based on a purchase history of the user.

(10)

The information processing apparatus according to any one of (1) to (9), wherein

the first and second articles are clothing.

(11)

The information processing apparatus according to any one of (1) to (10), wherein

the output part superimposes and displays a virtual object associated with the second article selected on the first article.

(12)

The information processing apparatus according to (11), wherein

the output part changes the virtual object to be displayed in accordance with a posture of the user.

(13)

The information processing apparatus according to (1), wherein

the output part presents, to the user, a display of an outfit example associated with the second article selected.

(14)

The information processing apparatus according to (1), wherein

the output part presents, to the user, a display of a wearing comfort level associated with the second article selected based on material information on the plurality of second articles pre-stored in the database.

(15)

An information processing method comprising:

acquiring three-dimensional shape data on a first article possessed by a user;

calculating, by comparing the three-dimensional shape data on the first article with three-dimensional shape data on a plurality of second articles pre-stored in a database managed by an electronic commerce business operator, a degree of similarity between the first article and each of the second articles;

selecting the second article to be recommended to the user based on each of the degrees of similarity; and

outputting, to the user, information on the second article selected.

(16)

A program for causing a computer to execute functions of:

acquiring three-dimensional shape data on a first article possessed by a user;

calculating, by comparing the three-dimensional shape data on the first article with three-dimensional shape data on a plurality of second articles pre-stored in a database managed by an electronic commerce business operator, a degree of similarity between the first article and each of the second articles;

selecting the second article to be recommended to the user based on each of the degrees of similarity; and

outputting, to the user, information on the second article selected.

### REFERENCE SIGNS LIST

10 INFORMATION PROCESSING SYSTEM
100 SERVER
102 SCAN CONTROLLER
104 SCAN DATA ACQUISITION PART
106 SERVER DATA ACQUISITION PART
108 MATCHING PART
110 CONTEXT DATA ACQUISITION PART
112 SELECTION PART
116 OUTPUT PART
118 PURCHASE PROCESSING PART
300 CAMERA
400 OUTPUT DEVICE
700, 702 CLOTHING
800, 806, 808 DISPLAY SCREEN
804, 812, 832 VIRTUAL OBJECT
810 ROOM
830 FURNITURE
900 INFORMATION PROCESSING APPARATUS
950 CPU
952 ROM
954 RAM
956 RECORDING MEDIUM
958 INPUT/OUTPUT INTERFACE
960 OPERATION INPUT DEVICE
962 DISPLAY DEVICE
964 AUDIO OUTPUT DEVICE
966 OUTPUT DEVICE
968 COMMUNICATION INTERFACE
970 BUS
980 SENSOR

1. An information processing apparatus comprising:
a shape information acquisition part configured to acquire three-dimensional shape data on a first article possessed by a user;
a degree of similarity calculation part configured to calculate, by comparing the three-dimensional shape data on the first article with three-dimensional shape data on a plurality of second articles pre-stored in a database managed by an electronic commerce business operator, a degree of similarity between the first article and each of the second articles;
a selection part configured to select the second article to be recommended to the user based on each of the degrees of similarity; and
an output part configured to output, to the user, information on the second article selected.

2. The information processing apparatus according to claim 1, wherein
the shape information acquisition part acquires the three-dimensional shape data on the first article from a TOF sensor configured to project light to the first article and detect the light to acquire the three-dimensional shape data on the first article.

3. The information processing apparatus according to claim 1, further comprising a color information acquisition part configured to acquire color information on a color of the first article.

4. The information processing apparatus according to claim 3, wherein
the degree of similarity calculation part calculates, by comparing the color information on the first article with the color information on the plurality of second articles, the degree of similarity between the first article and each of the second articles.

5. The information processing apparatus according to claim 1, wherein
the degree of similarity calculation part calculates the degree of similarity between identical parts among a plurality of parts of the first article and a plurality of parts of each of the second articles.

6. The information processing apparatus according to claim 5, wherein
the degree of similarity calculation part
sequentially calculates the degree of similarity between each set of the identical parts of the first article and each of the second articles and
weights the degree of similarity calculated.

7. The information processing apparatus according to claim 1, wherein
the selection part selects the second article in descending order of the degree of similarity.

8. The information processing apparatus according to claim 1, wherein
the selection part selects the second article based on profile information on the user.

9. The information processing apparatus according to claim 8, wherein
the selection part selects the second article based on a purchase history of the user.

10. The information processing apparatus according to claim 1, wherein
the first and second articles are clothing.

11. The information processing apparatus according to claim 1, wherein
the output part superimposes and displays a virtual object associated with the second article selected on the first article.

12. The information processing apparatus according to claim 11, wherein
the output part changes the virtual object to be displayed in accordance with a posture of the user.

13. The information processing apparatus according to claim 1, wherein
the output part presents, to the user, a display of an outfit example associated with the second article selected.

14. The information processing apparatus according to claim 1, wherein
the output part presents, to the user, a display of a wearing comfort level associated with the second article selected based on material information on the plurality of second articles pre-stored in the database.

15. An information processing method comprising:
acquiring three-dimensional shape data on a first article possessed by a user;
calculating, by comparing the three-dimensional shape data on the first article with three-dimensional shape data on a plurality of second articles pre-stored in a database managed by an electronic commerce business operator, a degree of similarity between the first article and each of the second articles;
selecting the second article to be recommended to the user based on each of the degrees of similarity; and
outputting, to the user, information on the second article selected.

16. A program for causing a computer to execute functions of:
acquiring three-dimensional shape data on a first article possessed by a user;
calculating, by comparing the three-dimensional shape data on the first article with three-dimensional shape data on a plurality of second articles pre-stored in a database managed by an electronic commerce business operator, a degree of similarity between the first article and each of the second articles;
selecting the second article to be recommended to the user based on each of the degrees of similarity; and
outputting, to the user, information on the second article selected.
